(19) United States
(12) Patent Application Publication
(10) Pub. No.: US 2025/0170747 A1
(43) Pub. Date: May 29, 2025

(54) PROCESS FOR THE MANUFACTURE OF SMALL BLOCKS MADE FROM WOOD FIBERS

(71) Applicant: IMAL S.r.l., Modena (MO) (IT)

(72) Inventor: Paolo BENEDETTI, Modena (MO) (IT)

(73) Assignee: IMAL S.r.l., Modena (MO) (IT)

(21) Appl. No.: 18/842,035

(22) PCT Filed: Feb. 28, 2023
(86) PCT No.: PCT/IB2023/051859

§ 371 Date: Aug. 27, 2024

(30) Foreign Application Priority Data
Mar. 2, 2022 (IT) 102022000003953

(51) Int. Cl. B27N 5/00; B65D 19/00

(52) U.S. Cl. CPC B27N 5/00; B65D 19/0028; B65D 2519/00029; B65D 2519/00064; B65D 2519/00273; B65D 2519/00288; B65D 2519/00323; B65D 2519/00338

(57) ABSTRACT

A process for the manufacture of small blocks made from wood fibers, including at least the following phases of: supply of one mixture of material based on wood fibers; supply of one extrusion channel and of one extruder body movable linearly by shifting within the extrusion channel along a direction of compaction; compaction of the mixture within the extrusion channel though the movement of the extruder body; extrusion and cutting of the compacted body having at least one free end along a cutting plane which is transverse to the direction of compaction at a predefined distance from the free end; wherein the predefined distance is greater than or equal to the lesser of either the first length or the second length.

### TECHNICAL FIELD

The present invention relates to a process for the manufacture of small blocks made from wood fibers.

### BACKGROUND ART

Specifically, the term “wood fibers” refers to wood fragments, of different sizes, obtained by means of a chipping operation of the wood itself and, subsequently, dried in special dryers, sorted and then mixed with resins and adhesives. The fragments may be in the form of flakes or powder. Specifically, flakes are elongated fragments while powder is fine wooden material.

Wood fiber small blocks are generally used as intermediate material for making more complex structures such as, e.g., pallets or the like.

The processes for the manufacture of small blocks made from wood fibers of known type involve compacting the wood fibers and resins to obtain a compacted body.

Specifically, compaction is carried out using special compacting means and comprises a pressing phase and a heating phase of the wood fibers, thus achieving an extrusion process. Heating, in addition to activating the adhesives and/or resins, results in a softening of the wood fibers, which are, therefore, more compressible and moldable.

Known processes generally involve manufacturing the compacted body of the desired dimensions and then sectioning it along planes which are transverse to the longitudinal (or compaction) direction of the compacted body itself, to obtain the small blocks. Sectioning of the compacted body along the longitudinal direction generally occurs at a shorter distance than the other dimensions (defined by the dimensions of the extrusion channel) so as to define the thickness of the small block obtained.

During the compaction phase, the fibers of the wood material are arranged substantially in planes parallel to each other and orthogonal to the direction of compaction. It follows, therefore, that the sectioning of the compacted body takes place parallel to the arrangement of the fibers of the wood material and that the small blocks thus obtained have the fibers arranged substantially orthogonally to the sides that define the thickness thereof.

In other words, the small blocks have two main faces opposite each other, obtained by means of the sectioning operations and bounded by the sides having greater dimensions, and four side faces, positioned between the main faces and contiguous to each other, which are bounded by one of the sides of the main faces and by the smaller side defining the thickness of the small blocks themselves. The fibers of the small blocks are thus oriented substantially parallel to the main faces of the relevant small blocks.

This results in the small blocks thus obtained having reduced mechanical strength since they tend to flake when subjected to shear operations.

In particular, when the small blocks are struck, e.g., by the forks of a forklift truck they tend to open since the forks fit between the parallel planes of the fibers.

It follows, therefore, that the small blocks thus obtained are low in strength and short in service life, resulting in high material waste and production costs.

### DESCRIPTION OF THE INVENTION

The main aim of the present invention is to devise a process for the manufacture of small blocks made from wood fibers which allows small blocks to be obtained having higher mechanical strength than those obtained by the production methods known to date.

Within this aim, one object of the present invention is to manufacture small blocks made from wood fibers in which the fibers are arranged substantially parallel to the sides that define the thickness thereof.

A further object of the present invention is to devise a process for the manufacture of small blocks made from wood fibers which allows small blocks to be obtained having greater mechanical strength to possible shear forces than those obtained with manufacturing processes of known type.

Another object of the present invention is to devise a process for the manufacture of small blocks made from wood fibers which can overcome the aforementioned drawbacks of the prior art within the framework of a simple, rational, easy and effective to use as well as affordable solution.

The aforementioned objects are achieved by this process for the manufacture of small blocks made from wood fibers having the characteristics of claim 1.

Additionally, the aforementioned objects are achieved by a process for the manufacture of a wood pallet having the characteristics of claim 7 as well as of a wood pallet having the characteristics of claim 11.

### BRIEF DESCRIPTION OF THE DRAWINGS

Other characteristics and advantages of the present invention will become more apparent from the description of a preferred, but not exclusive, embodiment of a process for the manufacture of small blocks made from wood fibers, illustrated by way of an indicative, yet non-limiting example in the accompanying tables of drawings in which:

FIG. 1 is a schematic representation of the extrusion and cutting phases of a process according to the invention;

FIG. 2 is an axonometric view of a small block obtained by means of a process according to the invention;

FIG. 3 is an axonometric view of a wood pallet provided with a plurality of small blocks obtained by means of a process according to the invention.

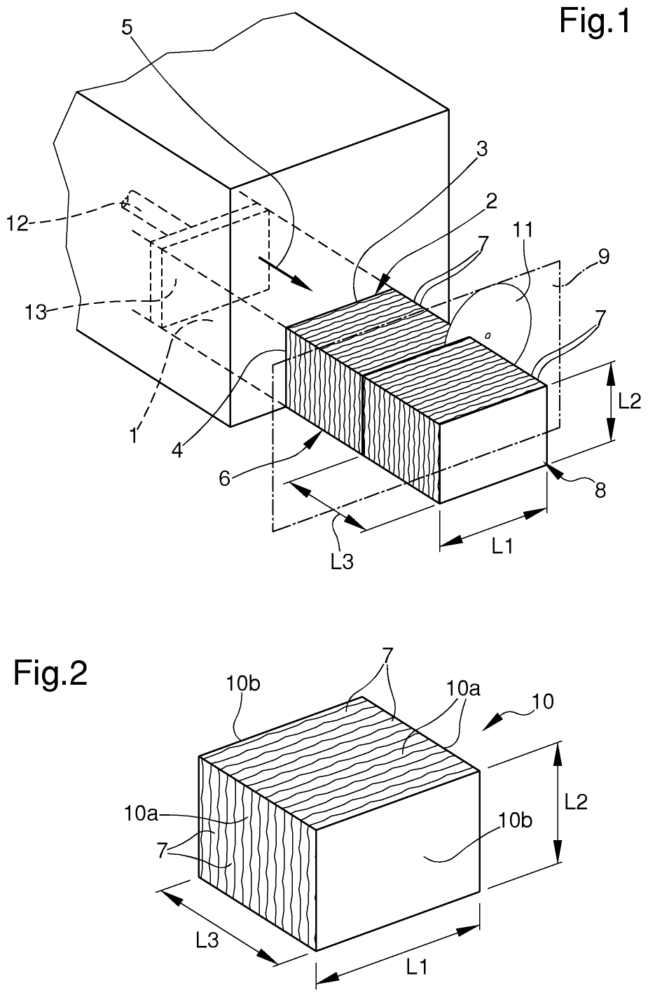

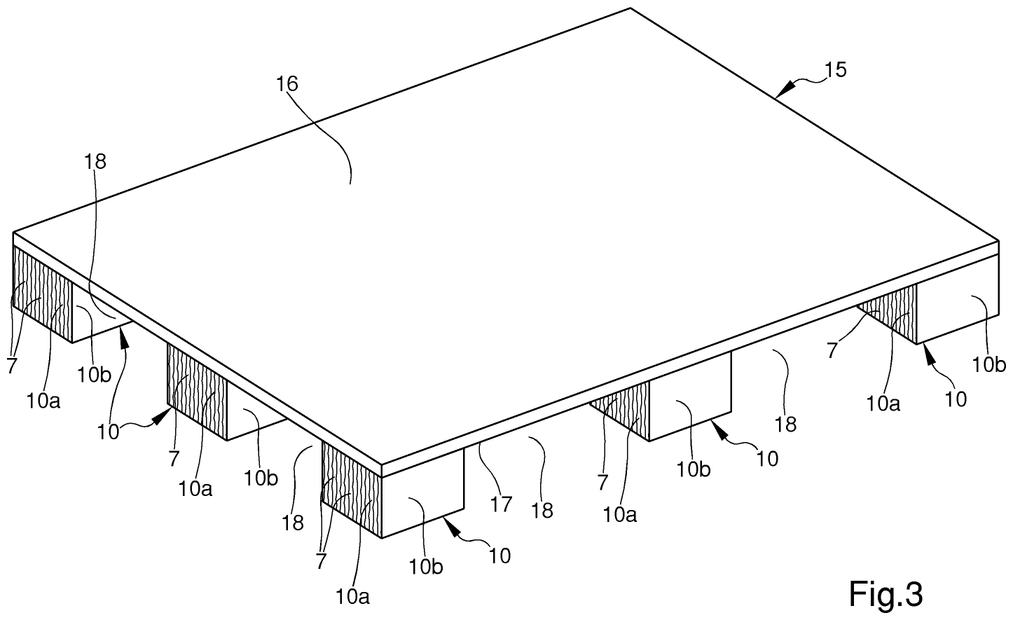

### EMBODIMENTS OF THE INVENTION

The process for the manufacture of small blocks made from wood fibers first involves a phase of supply of a mixture of material based on wood fibers, in the form of flakes and having a substantially elongated conformation, and resin.

In the context of the present disclosure, the term “wood fibers” refers to a set of wood fragments, of different sizes, obtained through a chipping operation of the wood itself, in the form of flakes and/or powder. In particular, flakes are elongated fragments.

These fragments are then dried in special dryers and bound together with adhesives and/or resins. Resins are selected from urea resins, isocyanate resins and natural resins.

Next, the process for the manufacture of small blocks made from wood fibers involves the supply of an extrusion channel 1, intended to receive the mixture of material based on wood fibers, which has an outlet port 2 shaped like a parallelogram. The outlet port 2 then has a pair of first sides 3 with a first length L1 and a pair of second sides 4 with a second length L2. The first sides 3 are therefore parallel to each other, as are the second sides 4. In the embodiment shown in the figures, the first sides 3 and the second sides 4 are perpendicular to each other.

Next, the process for the manufacture of small blocks made from wood fibers comprises a phase of supply of at least one extruder body 12 shaped complementary to the extrusion channel 1 and movable linearly by shifting within the extrusion channel 1 along a direction of compaction 5. The extruder body 12 defines a thrust plane 13 transverse to the direction of compaction and adapted to contact the material mixture.

Following the insertion of the material mixture within the extrusion channel 1, the mixture itself is compacted by moving the extruder body 12 along the direction of compaction 5 so as to obtain a compacted body 6. The direction of compaction corresponds, in actual facts, to the direction of longitudinal development of the compacted body 6.

As a result of compaction along the direction of compaction 5, the fibers are arranged substantially coplanar to the thrust plane 13 and along lying planes transverse to the direction of compaction itself. In the figures, the lying planes are identified with the arrows 7. More specifically, the fibers are arranged along lying planes substantially orthogonal to the direction of compaction 5. The term “substantially” is used herein because, since they are fibers, some of them may not have a well-defined geometric orientation, so the lying planes 7 may have a conformation that is not exactly planar.

The phase of compaction is carried out by means of the extruder body 12 which, when operated, is adapted to linearly press the material mixture, and heating means, adapted to heat the mixture itself so as to activate the resins.

In more detail, the heating means comprise injection means for injecting dry saturated vapor into the material mixture.

The dry saturated vapor allows heat transfer to the fibers without compromising the moisture content of the finished compacted body 6.

High moisture content, in fact, can lead to a number of problems such as, e.g., aesthetic defects, inadequate activation of resins and/or adhesives, to even reduction in the stiffness and mechanical strength of the compacted body 6.

Vapor penetrates the material mixture, rapidly raising the temperature to 100° C., a temperature at which polymerization of the resins begins.

Heating, in addition to activating the adhesives and/or resins, results in softening of the wood fibers which are, therefore, more compressible and moldable.

In more detail, the compaction of the material mixture is carried out in a substantially continuous manner, thus causing the extrusion of the compacted body 6 along the direction of compaction 5, through the outlet port 2. The compacted body 6 exiting the outlet port 2 thus has a free end 8.

More particularly, the cross section of the compacted body 6 corresponds to that of the outlet port 2.

Following the exit of the compacted body 6 through the outlet port 2, the compacted body itself is cut along a cutting plane 9 which is transverse to the direction of compaction 5, so as to obtain a small block 10 made from wood fibers.

More particularly, the cutting plane 9 is substantially parallel to the outlet port 2 and orthogonal to the direction of compaction 5.

The cut is made at a predefined distance L3 from the free end 8. Thus, the sides of the small block 10 thus obtained have a first dimension corresponding to the first length L1, a second dimension corresponding to the second length L2 and a third dimension corresponding to the predefined distance L3.

Appropriately, the small blocks 10 thus obtained are conformed substantially like a parallelepiped.

Cutting is carried out by means of a cutting unit 11, e.g. of the type of a circular blade, adapted to cut the compacted body 6 along the cutting plane 9.

Advantageously, in a particular embodiment, the cutting unit 11 comprises a plurality of blades, so that a plurality of cuts can be made simultaneously and a plurality of small blocks 10 can be obtained by an individual operation. In this case, each cut is made at a predefined distance L3 from the cut preceding it along the direction of compaction 5, that is, from the cut arranged downstream of the direction of compaction itself.

According to the invention, the predefined distance L3 at which the compacted body 6 is cut is greater than or equal to the lesser of either the first length L1 or the second length L2, so that the small block 10 thus obtained has at least four main faces 10a, arranged orthogonally to the cutting plane 9, having a main side defined by the predefined distance L3 and wherein the lying planes 7 are arranged transverse to the main side, and at least two cutting faces 10b obtained by means of the cutting phases and opposite each other, which are (partly) bounded by the side having the smallest dimension than the others. In the small blocks 10 thus obtained, the fiber lying planes 7 are arranged transverse to the main faces 10a and parallel to the cutting faces 10b.

More particularly, following the cutting phases, the main faces 10a of the small blocks 10 thus obtained are then arranged orthogonally to the corresponding cutting planes 9.

In other words, the main faces 10a of the small blocks 10 are oriented parallel to the direction of compaction 5.

Preferably, the predefined distance L3 is greater than the lesser of either the first length L1 or the second length L2.

It follows, therefore, that the sides corresponding to the lesser of either the first length L1 or the second length L2 define the thickness of the relevant small block 10, while the sides defined by the other two dimensions define the width and length of the small block 10, respectively.

In other words, the lesser of the sides bounding the cutting faces 10b defines the thickness of the relevant small block 10.

In the case where the first length L1 and the second length L2 are equal to each other, the small blocks 10 thus obtained have equal thickness and width, and the predefined distance L3 would define the length of the small block itself, i.e., the sides having greater dimensions.

Advantageously, a further phase of sectioning the small blocks 10 thus obtained can also be carried out along a sectional plane parallel to the main faces 10a of the small blocks themselves, so as to obtain two or more small blocks 10 having a smaller size than the small block from which they derive but which, at the same time, maintain the same arrangement of the fiber lying planes 7 i.e., transverse to the main faces 10a thereof.

A further aspect of the present invention relates to a process for the manufacture of wooden pallets.

The process for the manufacture of wooden pallets 14 comprises at least the phase of supply of at least one platform element 15 provided with at least one load-bearing face 16, adapted to hold at least one commodity, and with at least one mating face 17, opposite the load-bearing face 16.

The load-bearing face 16 and the mating face 17 are substantially parallel.

During the use of the pallet 14, the load-bearing face 16 and the mating face 17 are arranged substantially horizontally, and specifically, the load-bearing face 16 faces upwards while the mating face 17 faces downwards.

The load-bearing face 16 defines a substantially horizontal resting surface for a commodity to be deposited on the pallet 14.

The process for the manufacture of a wooden pallet 14 comprises the phase of supply of at least one small block 10 made according to the process according to the invention.

Precisely, the process for the manufacture of a wooden pallet 14 involves the supply of a plurality of small blocks 10.

Next, the process for the manufacture of a wooden pallet 14 involves the phase of attaching the platform element 15 to the plurality of small blocks 10 with the mating face 17 arranged to rest on at least one of the main faces 10a of at least one of the small blocks 10.

Conveniently, the process for the manufacture of the pallet 14 involves the phase of attaching being carried out by arranging the mating face 17 coupling on a main face 10a of each of the small blocks 10.

As a result of the coupling of the platform element 15 with the small blocks 10, the cutting faces 10b of the small blocks 10 are arranged transverse to the load-bearing face 16.

In more detail, the cutting faces 10b of the small blocks are arranged perpendicularly to the load-bearing face 16.

The remaining main faces 10a of the small blocks 10 arranged transversely to the load-bearing face 16 are accessible from the outside and the fiber lying planes 7 at these main faces 10a are arranged, in use, vertically.

The main face 10a of each small block 10 opposite the face 10a associated with the mating face 17 is arranged parallel to the mating face 17.

In the context of this disclosure, the term “in use” refers to the condition of normal use of the pallet 14, wherein the latter is arranged with the main faces 10a of each small block 10 opposite the faces 10a associated with the mating face 17 resting on the ground or on a substantially horizontal surface.

Consequently, the remaining main faces 10a and the relevant lying planes 7 are arranged substantially vertically.

Preferably, the small blocks 10 are spaced apart from each other to define a plurality of through cavities 18 between them.

During the movement of a wooden pallet 14, generally, gripping and movement means are used of the type of forklift trucks and/or pallet trucks.

Precisely, the forks of the forklift truck or pallet truck are inserted within the through cavities 18 and then the forks are lifted so as to be arranged in contact with the mating face 17 by lifting and holding the wooden pallet 14.

During the insertion of the forks into the through cavities 18, the forks are then moved along a direction substantially parallel to the mating face 17 that is, in use, substantially horizontal.

Usually, during the insertion of the forks into the through cavities 18 it may happen that the forks are not centered with respect to the through cavity 18 and get in contact with the small blocks 10, pushing on the main faces 10a accessible from the outside and the lying planes 7 of which are substantially vertical i.e., orthogonal to the direction of movement of the forks.

By virtue of their special orientation, the lying planes 7 give stiffness to the small blocks 10 with respect to a shear force, such as may be the force exerted by the forks that are unlikely to tear the small blocks 10.

An additional aspect of the present invention relates to a wooden pallet.

The wooden pallet 14 comprises:
the platform element 15 provided with the load-bearing face 16, adapted to hold at least one commodity, and the mating face 17, opposite the load-bearing face 16;
a plurality of small blocks 10, wherein at least one of the small blocks 10 is associated with the mating face 17 with one of its main faces 10a, the relevant cutting faces 10b being arranged transversely to the load-bearing face 16 and the remaining main faces 10a transverse to the load-bearing face 16 being accessible from the outside, where the fiber lying planes 7, at these main faces 10a, are arranged, in use, vertically.

It has in practice been ascertained that the described invention achieves the intended objects, and in particular the fact is emphasized that the choice of the predefined distance at which the cutting of the compacted body is carried out allows the fibers to be arranged in a direction substantially parallel to the thickness of the small blocks thus obtained.

Since the small blocks are generally used by arranging them with one of their main faces resting on an abutment surface, any shocks or stresses that the small block thus placed would experience, such as impact with the forks of a forklift truck, would not lead to the small block itself breaking or flaking as the stress received would be orthogonal to the fiber lying planes.

Thus, the arrangement of fiber lying planes within the small block obtained by the method according to the invention allows for greater mechanical strength, particularly at shear stresses.

1. A process for manufacture of small blocks made from wood fibers, the process comprising at least the following phases of:
supply of at least one mixture of material based on the wood fibers, in a form of flakes and having a substantially elongated conformation, and resin;
supply of at least one extrusion channel provided with at least one outlet port substantially shaped like a parallelogram and having a pair of first sides with a first length and a pair of second sides with a second length;
supply of at least one extruder body shaped substantially complementary to said at least one extrusion channel, wherein said at least one extruder body is movable linearly by shifting within said at least one extrusion channel along a direction of compaction, defines at least one thrust plane transverse to said direction of compaction and is adapted to contact the at least one mixture of material;
compaction of said at least one mixture of material within said at least one extrusion channel though movement of said at least one extruder body along said direction of compaction so as to obtain a compacted body, the wood fibers of said at least one mixture of material arranging in a substantially coplanar manner to said at least one thrust plane and on lying planes which are transverse to said direction of compaction;
extrusion of said compacted body through said at least one outlet port said compacted body having at least one free end exiting from said at least one outlet port; and
cutting of said compacted body along a cutting plane which is transverse to said direction of compaction at a predefined distance from said at least one free end along said direction of compaction so as to obtain a small block made from the wood fibers, sides of which have a first dimension corresponding to said first length, a second dimension corresponding to said second length and a third dimension corresponding to said predefined distance; wherein
said predefined distance is greater than or equal to the lesser of either said first length or said second length so that said small block has four main faces arranged orthogonally to said cutting plane, having a main side defined by said predefined distance and at which said lying planes are arranged transverse to said main side, and at least two cutting faces opposite each other, obtained by means of said cut and bounded by a side having a smaller dimension than the others.

2. The process according to claim 1, wherein said predefined distance is greater than the lesser of either said first length or said second length.

3. The process according to claim 1, wherein said cut comprises simultaneously performing a plurality of said cuts, where each of said cuts is placed at said predefined distance from a previous cut along said direction of compaction.

4. The process according to claim 1, further comprising: at least one phase of sectioning said small block along a sectional plane which is orthogonal to said cutting faces.

5. The process according to claim 1, wherein said cutting plane is arranged orthogonally to said direction of compaction.

6. The process according to o claim 1, wherein said small block is substantially shaped like a parallelepiped.

7. A manufacturing process of wooden pallets comprising at least the following phases:
supply of at least one platform element provided with at least one load-bearing face, adapted to hold at least one commodity, and with at least one mating face, opposite said load-bearing face;
supply of at least one small block made according to the process according to claim 1; and
attaching said platform element to a plurality of said small blocks with said mating face arranged to rest on at least one of said main faces of at least one of said small blocks, wherein the relevant said cutting faces are arranged transverse to said load-bearing face and wherein the remaining main faces arranged transversely to said load-bearing face are accessible from an outside and with the relevant fiber lying planes arranged, in use, vertically.

8. The manufacturing according to claim 7, wherein said attaching is carried out by arranging said mating face resting on a main face of each of said small blocks.

9. The manufacturing according to claim 8, wherein said small blocks are arranged spaced apart from each other to define a plurality of through cavities between said small blocks.

10. The manufacturing according to claim 9, wherein said cutting faces of said small blocks are arranged perpendicularly to said load-bearing face.

11. A wooden pallet comprising:
at least one platform element provided with at least one load-bearing face, adapted to hold at least one commodity, and with at least one mating face, opposite said load-bearing face; and
a plurality of small blocks according to claim 1, wherein at least one of said small blocks is associated with said mating face with one of its main faces, the relevant cutting faces being arranged transversely to said load-bearing face and the remaining main faces transverse to said load-bearing face being accessible from an outside and with the relevant fiber lying planes arranged, in use, vertically.
